(19) United States
(12) Patent Application Publication
(10) Pub. No.: US 2018/0239449 A1
(43) Pub. Date: Aug. 23, 2018

(54) ACTIVE STYLUS AND CONTROL METHOD THEREOF

(71) Applicant: inputek Co., Ltd., Hsinchu County (TW)

(72) Inventors: Tse Yen LIN, Hsinchu County (TW); Chi Chin CHEN, Hsinchu County (TW); Wen Yi LEE, Hsinchu County (TW); Chia Wei WU, Hsinchu County (TW)

(21) Appl. No.: 15/599,357

(22) Filed: May 18, 2017

(30) Foreign Application Priority Data
Feb. 17, 2017 (CN) 201710092494.4
Feb. 17, 2017 (TW) 106105393

(51) Int. Cl. G06F 3/0354; G06F 3/044; G06F 3/041; G06F 3/038

(52) U.S. Cl. CPC G06F 3/03545; G06F 3/044; G06F 2203/04104; G06F 3/0383; G06F 3/0416

(57) ABSTRACT

An active stylus that is applicable to a touch panel. The touch panel comprises driving electrodes and sensing electrodes. Each driving electrode transmits a panel driving signal. The sensing electrodes receive the panel driving signal. The active stylus comprises a receiving element receiving the panel driving signal; a sensing module obtaining signal characteristics of the panel driving signal; a signal generator generating a simulated driving signal; a driving element transmitting the simulated driving signal; and a control unit. The control unit uses the signal generator to generate the simulated driving signal, which is synchronous with and identical in phase to the panel driving signal, according to the signal characteristics of the panel driving signal. Thereby, the touch panel can distinguish the touch of an active stylus from the touch of a hand and realize a multi-point touch control function in a mutual-capacitance mode.

### FIELD OF THE INVENTION

The present invention relates to a stylus, particularly an active stylus.

### BACKGROUND OF THE INVENTION

At present, the mainstream projection type capacitive touch panel adopts a mutual-capacitance structure and normally has a plurality of driving electrodes disposed intermittently and a plurality of sensing electrodes disposed intermittently and crossing the driving electrodes. The intersections of the driving electrodes and the sensing electrodes form sensing capacitors. While a finger touches the touch panel, the statuses of the corresponding sensing capacitors vary. Thereby, the touch panel can learn the position where the finger touches.

A stylus often functions as an assistant tool for the user while writing or drawing on a touch panel. The styluses in the market can be categorized into the passive type and the active type. The active stylus can generate driving signals, which can be sensed by the sensing electrodes of a touch panel. However, the passive stylus cannot generate any driving signal. The current active stylus normally generates driving signals simulating a finger to make statuses of the sensing capacitors of a touch panel vary. However, the control chip of the touch panel cannot distinguish the touch of an active stylus from the touch of a palm. There have been manufacturers providing touch panels whose operation modes can be switched. However, the control chip of this type of touch panel cannot discriminate the touch of an active stylus from the touch of a palm unless the touch panel is in a self-capacitance mode, wherein all the electrodes (including the driving electrodes) are switched into sensing electrodes). Nevertheless, this type of touch panel can only support single-point touch control. Accordingly, it has been a target the manufacturers are eager to achieve that the active stylus can realize multi-point touch control and palm rejection.

### SUMMARY OF THE INVENTION

One objective of the present invention is to provide an active stylus and a control method thereof, which supports multi-point touch control and enables a touch panel to distinguish the touch of an active stylus from the touch of a palm.

In order to achieve the abovementioned objective, the present invention proposes an active stylus applicable to a touch panel. The touch panel comprise s a plurality of driving electrodes and a plurality of sensing electrodes. Each driving electrode transmits a panel driving signal. The sensing electrodes receive the panel driving signal. The active stylus comprises a receiving element, a sensing module, a signal generator, a driving element, and a control unit. The receiving element receives the panel driving signal. The sensing module is coupled to the receiving element, responding to the panel driving signal and obtaining the signal characteristics of the panel driving signal. The signal generator generates a simulated driving signal. The driving element is coupled to the signal generator and transmits the simulated driving signal. The control unit is coupled to the sensing module and the signal generator, using the signal generator to generate the simulated driving signal, which is synchronous with the panel driving signal and identical in phase to the panel driving signal, according to the signal characteristics of the panel driving signal.

The present invention also proposes a control method of an active stylus. The active stylus is applicable to a touch panel. The touch panel comprise a plurality of driving electrodes and a plurality of sensing electrodes. Each driving electrode transmits a panel driving signal. The sensing electrodes receive the panel driving signal. The control method comprises steps: receiving the panel driving signal; acquiring the signal characteristics of the panel driving signal; generating a simulated driving signal, which is synchronous with the panel driving signal and identical in phase to the panel driving signal, according to the signal characteristics of the panel driving signal; and transmitting the simulated driving signal.

The phase of a finger touch signal detected by the sensing electrodes is opposite to the phase of the panel driving signal. While a finger and the active stylus simultaneously touch the touch panel, the sensing electrodes would detect signals of different phases. Thus, the touch panel can discriminate an active stylus from a finger. Besides, the touch panel can support the multi-point touch control of the active stylus in a mutual-capacitance mode without switching the driving electrodes into the sensing electrodes.

### BRIEF DESCRIPTION OF THE DRAWINGS

FIG. 1 is a block diagram schematically showing the elements of an active stylus according to one embodiment of the present invention;

FIG. 2 is a diagram schematically showing a touch panel;

FIG. 3 is a flowchart of a control method of an active stylus according to one embodiment of the present invention;

FIG. 4A is a diagram showing an example of the waveform of a panel driving signal sent out by the driving electrode;

FIG. 4B is a diagram showing an example of the waveform of a signal intensity detected by the capacitance detector;

FIG. 4C is a diagram showing an example of the waveform of a simulated driving signal; and

FIG. 5 is a diagram schematically showing that an active stylus is used to write on a touch panel and waveforms generated thereby according to one embodiment of the present invention.

### DETAILED DESCRIPTION OF THE PREFERRED EMBODIMENTS

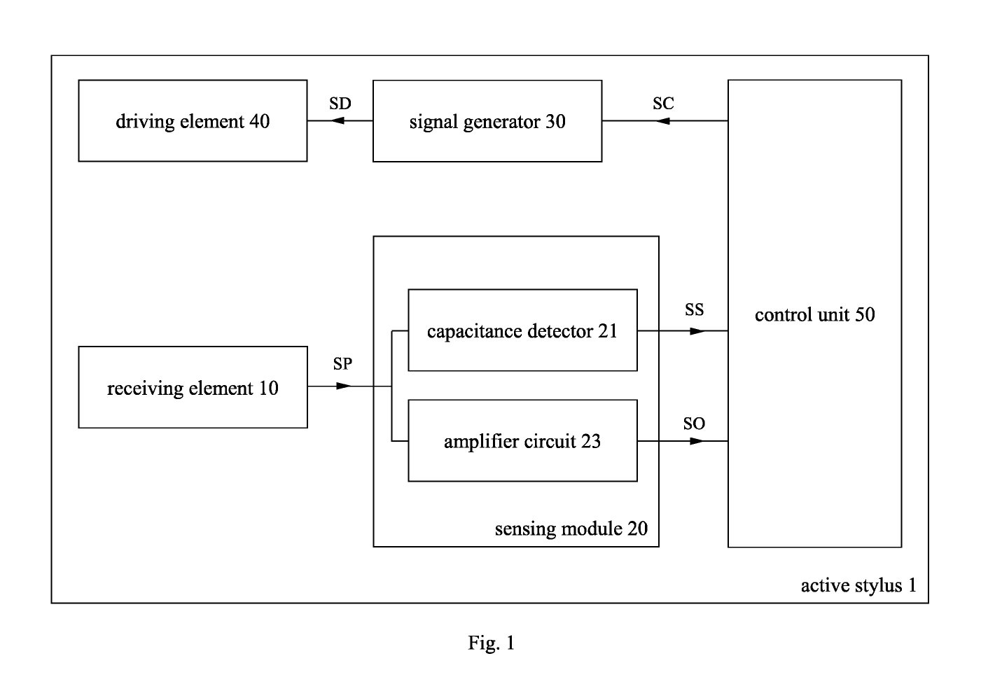

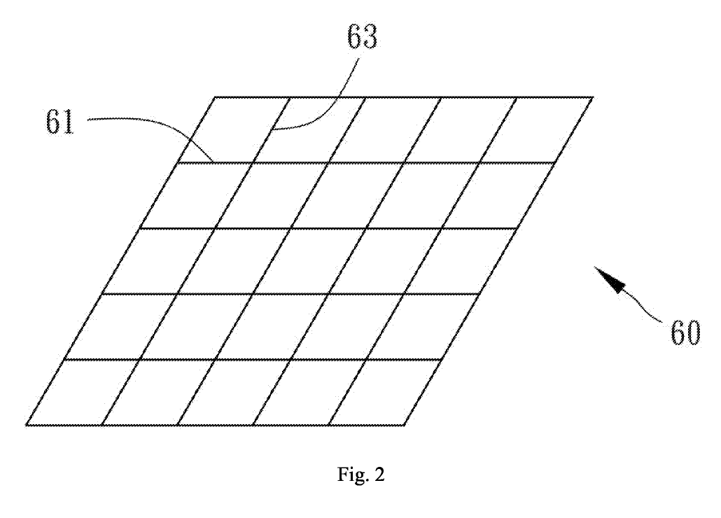

Refer to FIG. 1 a block diagram schematically showing the elements of an active stylus 1 according to one embodiment of the present invention. The active stylus comprises a receiving element 10, a sensing module 20, a signal generator 30, a driving element 40 and a control unit 50. The stylus 1 is applicable to a capacitive touch panel 60. Refer to FIG. 2 a diagram schematically showing a touch panel. The touch panel 60 comprises a plurality of driving electrodes 61 and a plurality of sensing electrodes 63 crossing the driving electrodes 61, i.e. the touch panel 60 is in a mutual-capacitance structure. Each driving electrode 62 transmits a panel driving signal SP, and the sensing electrodes 63 receive the panel driving signal SP.

It should be explained: the quantities of the driving electrodes 61 and the sensing electrodes 63 shown in FIG. 2 are only to exemplify the structure of the touch panel 60 but not to limit the structure of touch panel 60. In other embodiments, the driving electrodes 61 or the sensing electrodes 63 may have different quantities.

The receiving element 10 may be made of a conductive material able to receive (sense) the panel driving signals SP, such as a metal, a metal oxide, or graphene. The receiving element 10 is used to receive the panel driving signals SP.

The sensing module 20 is coupled to the receiving element 10 to obtain the signal characteristics of the panel driving signal SP, such as intensities, peak values, valley values and frequencies. The sensing module 20 includes a capacitance detector 21 and an amplifier circuit 23. The capacitance detector 21 responds to the panel driving signal SP and acquires a corresponding signal intensity SS (i.e. the amplitude or the sensed value). The amplifier circuit 23 responds to the panel signal SP and outputs an output signal SO. In one embodiment, the amplifier circuit 23 is a comparator. The panel driving signal SP and a reference signal (related to the peak value of the panel driving signal SP) are input to the comparator. If the intensity of the panel driving signal SP is higher than the intensity of the reference signal, the comparator outputs a high-level output signal SO. If the intensity of the panel driving signal SP is lower than the intensity of the reference signal, the comparator outputs a low-level output signal SO.

It should be explained: the capacitance detector 21 and the amplifier circuit 23 are integrated into a module, chip or circuit in some embodiments, and they are two independent units in other embodiments.

The signal generator 30 receives a control SC and generates a corresponding simulated driving signal SD according to the control signal SC. The control signal SC is used to indicate the signal characteristics of the simulated driving signal SD. In one embodiment, the signal characteristics of the simulated driving signal SD include simulated timing information (such as the start point, period or frequency of each cycle) and at least one of a duty cycle and an amplitude value.

The driving element 40 is made of a material identical or similar to the conductive material used by the receiving element 10. The driving element 40 is coupled to the signal generator 30 and transmits the simulated driving signal SD.

The control unit 50 is a microcontroller, a chip, a programmable dedicated or universal controller, or a combination thereof. The control unit 50 is coupled to the capacitance detector 21 and the amplifier circuit 23 of the sensing module 20 and the signal generator 30. The control unit 50 receives the signal intensity SS and the output signal SO. The control unit 50 further has functions of timing (e.g. having a built-in clock generator and an oscillator), calculation, and recording so as to transmit the control signal SC to the signal generator 30.

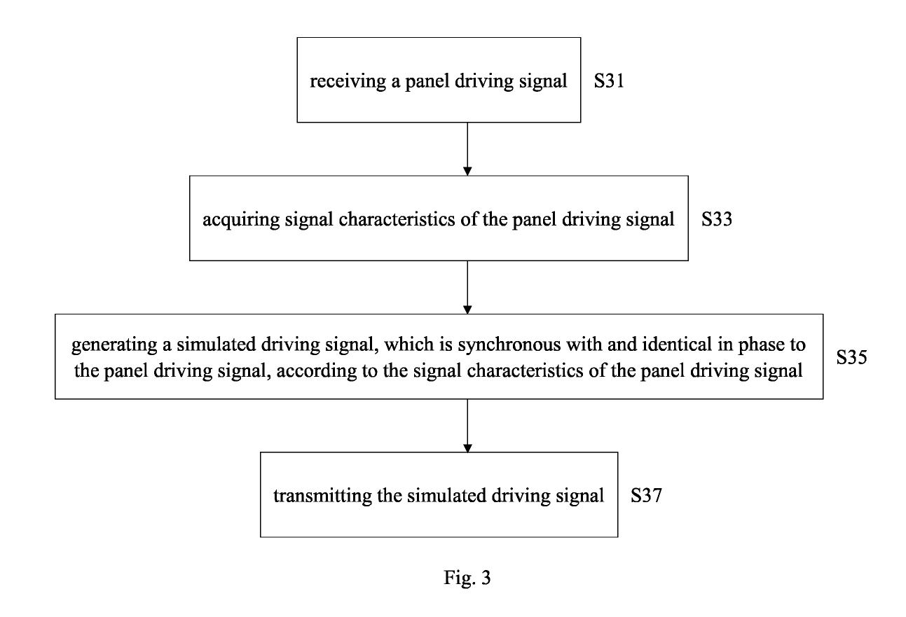

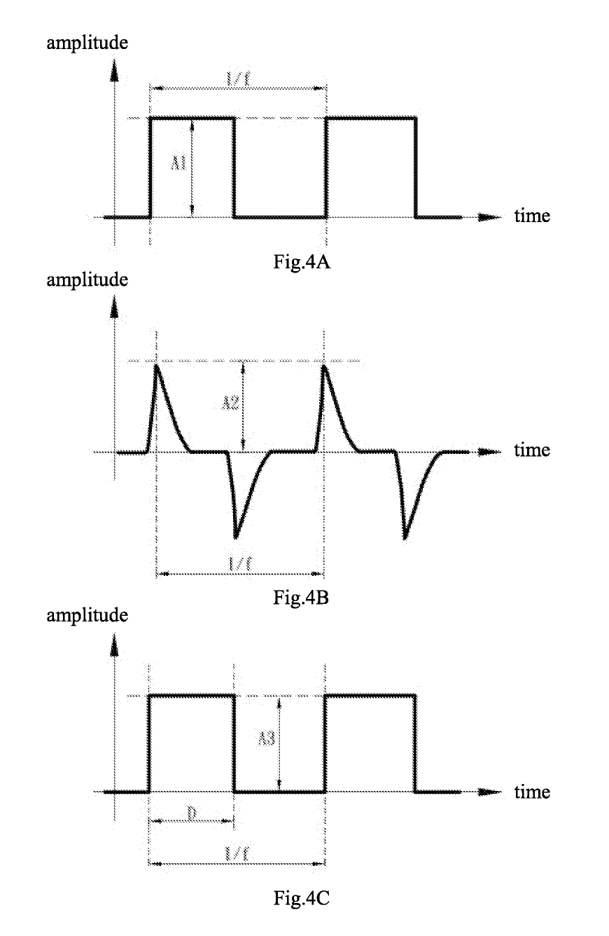

The circuit design of the active stylus 1 has been described above. The control method of the active stylus 1 will be described in cooperation with FIG. 3 and FIGS. 4A-4C below.

Refer to FIG. 4A a diagram showing an example of the waveform of the panel driving signal SP sent out by the driving electrode 61. The panel driving signal SP is a pulse signal having an amplitude of A1 and a frequency of f. Refer to FIG. 3 a flowchart of a control method of an active stylus according to one embodiment of the present invention. In Step S31, while the active stylus 1 approaches a point away from the touch panel 60 by a given distance (such as about 0.5-1 cm), the receiving element 10 can receive the panel driving signal SP.

In Step S33, the sensing module 20 acquires the signal characteristics of the panel driving signal SP. Refer to FIG. 4B a diagram showing an example of the waveform of the signal intensity SS detected by the capacitance detector 21. What the capacitance detector 21 detects is a signal having an amplitude of A2 and a frequency of f. Then, the capacitance detector 21 acquires the signal intensity SS of the panel driving signal SP.

In one embodiment, after acquiring the signal intensity SS of the panel driving signal SP, the control unit 50 responds to the distance between the active stylus 1 and the touch panel 60 and determines the signal characteristics of the simulated driving signal SD according to the signal intensity SS. In one embodiment, the signal characteristics of the simulated driving signal SD includes a duty cycle D and an amplitude value A3. Refer to Table (1) for the signal characteristics of the simulated driving signal SD.

TABLE (1)

| Frequency | | Amplitude A3 | |
|---|---|---|---|
| (kHz) | Duty cycle D | (voltage) | Signal intensity |
| 100 | 50% | 5 | −20 |
| 100 | 50% | 10 | −40 |
| 100 | 25% | 5 | −10 |
| 100 | 25% | 10 | −20 |
| 100 | 75% | 5 | −30 |
| 100 | 75% | 10 | −60 |

The signal intensity SS of the panel driving signal SP detected by the capacitance detector 21 correlates with the distance between the active stylus 1 and the touch panel 60. Therefore, the signal characteristics of the simulated driving signal SD varies with the signal intensity SS of the panel driving signal SP, wherein the product of the duty cycle D and the amplitude value A3 relates to the signal intensity SS detected by the capacitance detector 21.

The pulse width modulation (PWM) method and the pulse amplitude modulation (PAM) method used in this embodiment are only for exemplification. In other embodiments, the panel driving signal SP can be coded in another signal modulation method, and the simulated driving signal SD has to vary with the signal characteristics of the panel driving signal SP.

The amplifier circuit 23 outputs an output signal SO according to the signal intensity of the panel driving signal SP. The control unit 50 obtains two adjacent peak values of the panel driving signal SP according to the output signal SO output by the amplifier circuit 23. For example, while determining that the output signal SO varies from a low level to a high level, the control unit 50 works out the time difference between two adjacent peak values and obtains the frequency (the reciprocal of the time difference is the frequency f of the panel driving signal SP.) Then, the control unit 50 determines the simulated timing information of the simulated driving signal SD according to the timing information of the touch panel. In this embodiment, the frequency f of the panel driving signal SP is identical to the frequency f of the simulated driving signal SD. Besides, the control unit 50 can work out the start point of each cycle of the panel driving signal SP to synchronize the panel driving signal SP and the simulated driving signal SD.

It should be explained: there are also many other methods to calculate the frequency and period. For example, if the amplifier circuit 23 is an operation amplifier, the control unit 50 can obtain a peak value and an adjacent valley value of the panel driving signal SP, and the time difference between the peak value and the valley value can be used to work out the frequency. Alternatively, the control unit 50 can use the time difference between two adjacent valley values to work out the frequency.

In Step S35, according to the signal characteristics of the panel driving signal SP, the control unit 50 transmits to signal generator 30 the control signal SC, which is used to indicate the signal characteristics of the simulated driving signal SD, such as the frequency, the amplitude A3, the duty cycle D, and the start point of each cycle, to control the signal generator 30 to generate the simulated driving signal SD (shown in FIG. 4C) synchronizing with the panel driving signal SP, i.e. the frequency and the start points of the simulated driving signal SD are identical to these of the panel driving signal SP, as shown in FIG. 4A and FIG. 4C. In Step S37, the driving element 40 transmits the simulated driving signal SD.

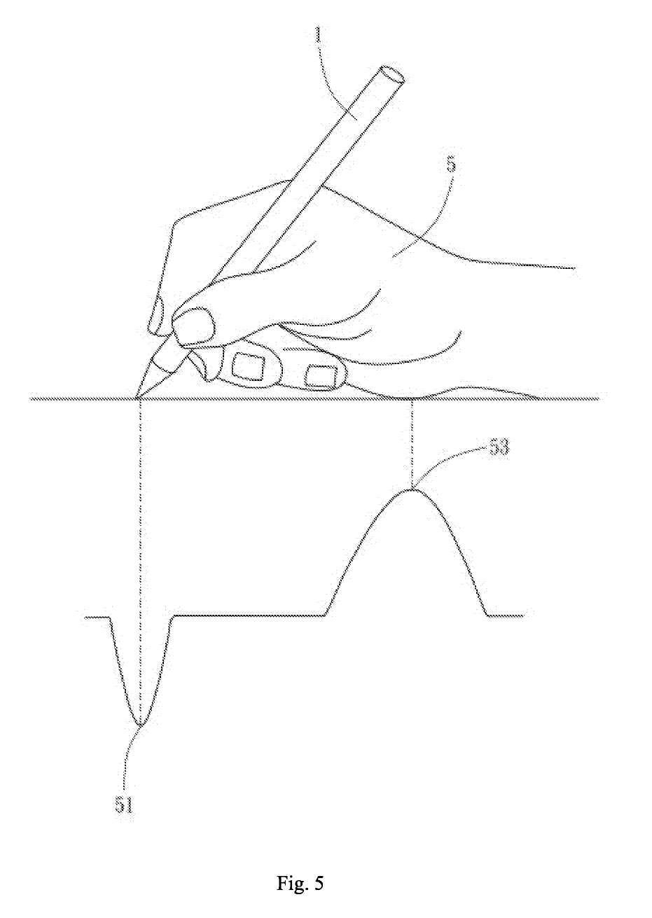

Refer to FIG. 5. While a hand 5 and the active stylus 1 touch the touch panel 60, the phase of the simulated driving signal SD sent out by the active stylus 1 is identical to that of the panel driving signal SP, and the touch panel 60 detects a signal intensity 51 of a negative value. Nevertheless, the capacitance variation induced by the hand 5 makes the touch panel 60 detect a signal intensity 53 of a positive value. Thus, the touch panel 60 can distinguish the touch of the active stylus 1 from the touch of the hand 5. In other words, the touch panel 60 can still recognize the touch of the active stylus 1 and the touch of the hand 5 in the mutual-capacitance mode (i.e. under the condition that the driving electrodes still transmit the panel driving signal SP.) Thereby, the touch panel 60 can filter out the signals induced by the hand 5 and realize a palm rejection function. Besides, while two or more active styluses 1 simultaneously approach the touch panel 60 in the mutual-capacitance mode, the touch panel 60 can sequentially detect the capacitance variations through the sensing electrodes 63 to learn the positions of the active styluses 1 with no ghost point appearing.

As the signal characteristics of the simulated driving signal SD correlates with the signal intensity SS acquired by the capacitance detector 21, i.e. correlates with the distance between the active stylus 1 and the touch panel 60, the touch panel 60 can determine the distance between the active stylus 1 and the touch panel 60 and emulate the pressures and other factors of the stylus touches according to the signal intensity of the simulated driving signal SD. It should be explained: the control unit 50 can still distinguish the touch of the active stylus 1 from the touch of the hand 5 and realize the multi-point touch control function with the duty cycle D and amplitude value A3 of the simulated driving signal SD being fixed.

The present invention has been demonstrated with the embodiments above. However, these embodiments are only to exemplify the present invention but not to limit the scope of the present invention. Any equivalent modification or variation without departing from the spirit of the present invention is to be also included by the scope of the present invention.

What is claimed is:

1. An active stylus applicable to a touch panel, wherein said touch panel comprise s a plurality of driving electrodes and a plurality of sensing electrodes; each of said driving electrode transmits a panel driving signal; said sensing electrodes receive said panel driving signal, and wherein said active stylus comprises
a receiving element receiving said panel driving signal;
a sensing module coupled to said receiving element, responding to said panel driving signal, and obtaining signal characteristics of said panel driving signal;
a signal generator generating a simulated driving signal;
a driving element coupled to said signal generator and transmitting said simulated driving signal; and
a control unit coupled to said sensing module and said signal generator, using said signal generator to generate said simulated driving signal, which is synchronous with said panel driving signal and identical in phase to said panel driving signal, according to said signal characteristics of said panel driving signal.

2. The active stylus according to claim 1, wherein said signal characteristics of said panel driving signal include a signal intensity, and wherein said sensing module includes a capacitance detector coupled to said receiving element and said control unit, responding to said panel driving signal and acquiring a corresponding signal intensity, and wherein said control unit determines signal characteristics of said simulated driving signal according to said signal intensity.

3. The active stylus according to claim 2, wherein said simulated driving signal is a pulse signal, and wherein said signal characteristics of said simulated driving signal includes at least one of a duty cycle and an amplitude.

4. The active stylus according to claim 1, wherein said signal characteristics of said panel driving signal include panel timing information, and wherein said signal characteristics of said simulated driving signal include simulated timing information, and wherein said sensing module includes an amplifier circuit coupled to said receiving element and said control unit, and wherein said amplifier circuit responds to said panel driving signal and outputs an output signal, and wherein said control unit obtains said panel timing information according to said output signal, and wherein said control unit determines said simulated timing information of said simulated driving signal according to said panel timing information.

5. The active stylus according to claim 4, wherein said timing information is a frequency, and wherein said control unit obtains two adjacent peak values of said panel driving signal according to said output signal and calculates time difference of said two peak values to obtain said frequency.

6. A control method of an active stylus applicable to a touch panel, wherein said touch panel comprises a plurality of driving electrodes and a plurality of sensing electrodes; each of said driving electrode transmits a panel driving signal; said sensing electrodes receive said panel driving signal, and wherein said control method comprises steps:
receiving said panel driving signal;
acquiring signal characteristics of said panel driving signal;
generating a simulated driving signal, which is synchronous with said panel driving signal and identical in phase to said panel driving signal, according to said signal characteristics of said panel driving signal; and
transmitting said simulated driving signal.

7. The control method of an active stylus according to claim 6, wherein said signal characteristics of said panel driving signal include a signal intensity, and wherein said step of acquiring signal characteristics of said panel driving signal includes steps:
responding to said panel driving signal and obtaining a corresponding signal intensity; and
determining signal characteristics of said simulated driving signal according to said signal intensity.

8. The control method of an active stylus according to claim 7, wherein said simulated driving signal is a pulse signal, and wherein said signal characteristics of said simulated driving signal include at least one of a duty cycle and an amplitude.

9. The control method of an active stylus according to claim 7, wherein said signal characteristics of said panel driving signal include panel timing information, and wherein signal characteristics of simulated driving signal include simulated timing information, and wherein said step of acquiring said signal characteristics of said panel driving signal includes steps:
acquiring said panel timing information according to said panel driving signal; and
determining said simulated timing information of said simulated driving signal according to said panel timing information.

10. The control method of an active stylus according to claim 9, wherein said timing information is a frequency, and wherein said step of acquiring said panel timing information according to said panel driving signal includes steps:
determining two adjacent peak values of said panel driving signal; and
calculating time difference of said two adjacent peak values to obtain said frequency.
